(19) United States
(12) Patent Application Publication
(10) Pub. No.: US 2004/0168900 A1
(43) Pub. Date: Sep. 2, 2004

(54) Staged heat and mass transfer applications

(76) Inventor: Peter Tung, Ancaster (CA)

Correspondence Address: Peter Tung, 63 Templer Drive, Ancaster, ON, L9G 3X7, CA

(21) Appl. No.: 10/376,210

(22) Filed: Feb. 27, 2003

(51) Int. Cl. B01D 3/02; B01D 3/14; B01D 3/42

(52) U.S. Cl. 202/155; 202/158; 202/160; 202/173

(57) ABSTRACT

This invention exploits the concept of Staged Heat and Mass Transfer (SHMT) to enhance operability, control robustness and intrinsic safety in preventing corrosion while recovering material, and energy if desirable, in process waste streams. Two applications illustrating the improvements based on the SHMT concept are given. One application illustrates novel design features to recover vent from a steam boiler deaeration system, positively eliminating the risk of oxygen and carbon dioxide accumulation in deaerator. The other application illustrates process adaptations of the same SHMT concept to recover steam, steam condensate, and fugitive emissions involving particulate materials if desirable, from any process vents from vessels that are opened to the atmosphere. Again, without the risk of corrosion by atmospheric oxygen.

### BACKGROUND

1. Field of Invention

This invention relates generally to processes involving heat and mass transfer applications. In a specific respect, the invention exploits the concept of “Staged Heat and Mass Transfer” (SHMT) as taught in U.S. patent application Ser. No. 09/536,283 to enhance operability, control robustness and intrinsic safety in preventing corrosion while recovering material, and energy if desirable, in process waste streams. Two applications illustrating the improvements based on the SHMT concept are given. One illustrates commercial applications of recovering vent from a steam boiler deaeration system. The other illustrates process adaptations to recover steam, steam condensate, and fugitive emissions involving particulate materials if desirable, from any process vents.

2. Discussion of Prior Art

The concept of SHMT application as explained in U.S. patent application Ser. No. 09/536,283 is briefly summarized. A structure comprising a heat transfer zone and a mass transfer zone separated by a movable imaginary boundary, with the heat transfer zone right above the mass transfer zone. Quenching takes place in the heat transfer zone and stripping takes place in the mass transfer zone. The movable boundary apportions the heat transfer duty and the mass transfer duty available within the common structure depending on the operating requirement. This prior art enables the capturing of otherwise vented steam from a deaerator, as an example, while ensuring the purging out of undesirable gaseous products like carbon dioxide and oxygen from the deaerator.

The inclusion of a mass transfer zone within the heat recovery unit to strip out gases like oxygen and carbon dioxide is novel in a deaerator vent recovery application.

While this prior art provides a tangible method to achieve the above objectives, there is room to enhance its application. More specifically, to improve on operability, reliability, and ease of installation; to lower installation and maintenance costs; and to enhance control robustness by incorporating built-in intrinsic safety features to further guard against purge gas reentry to the deaerator, and other desirable objectives.

Another area of opportunities can be found in the many vapor purge streams vented directly or indirectly to the atmosphere. Despite the obvious latent heat and condensate values in the steam, and perhaps the added cost impact of fugitive emissions of process elements like odor and products, there is few evidence of successful recovery due to many technical challenges inherent in these vents. The following three examples illustrate the potential benefits of applying the SHMT concept at these general areas. Other areas can also be made applicable by this current invention.

Condensate Receiving Vessels Directly Vented to the Atmosphere

Steam condensate streams from process heating are typically routed to receiving vessels equipped with atmospheric vents. The plumes can be either steady or intermittent depending on flow rate and heat content of incoming streams. Few vents, if any, are worth recovering due to these variability and lower heat quality. Ice buildups are nuisance and pose safety hazards during sub-zero weather conditions. It would be beneficial to stop the loss of steam condensate and, if practical, the associated heating value of these vents.

Condensate Receiving Vessels indirectly Vented to the Atmosphere

Sometimes steam vents from condensate receiving vessels are first routed through partial heat recovery units before discharging to the atmosphere, for example, drum dryer operations in the pulp and paper industry. The flash steam from condensate receiving vessel can be routed through a plenum economizer designed to recover heat from hot moist air from the dryers by direct or indirect contact heat exchange with incoming water before discharging to the atmosphere. The resulting condensate from the condensed steam, after coming into direct contact with the moist air from the dryers, can no longer be recycled as boiler feed water because of cross contamination. The condensate must be downgraded as a process waste. Alternatively, if the vent were to be kept free of contaminates by a closed chamber not vented to atmosphere, inadvertent over condensing could create a vacuum situation risking implosion of the vessel. Vacuum breakers to prevent such risk would introduce atmospheric oxygen to cause extensive corrosion. Consequently, efforts to recover these vents face many not readily apparent difficult challenges.

Process Vessels directly Vented to Atmosphere

Then there are situations where vents containing substantial amounts of water vapor are directly vented to the atmosphere, for example, vents during batch cooking in beer brewery and vents from hot lime mixing tanks in steel processing or chemical industries. These vents contain valuable water, heat and process by-products. It may be desirable to recover any or all of these contents for economic or environmental considerations.

The three outlined areas above share the convenience of venting to the atmosphere. This similarity points to an underlying difficulty not readily apparent. Not having this vent to the atmosphere for balancing pressure would help emphasize its importance. Very quickly, trying to replace this very “convenient” pressure regulation becomes a tall task.

The degree of difficulty in recovering heat, condensate and process emission can be further explained by the following analysis:

When a heat sink, such as a fluid at a lower temperature passing through a coil, is placed along the path of a vapor vent containing condensables, latent heat is being picked up by the heat sink. This heat flow to the heat sink results in some steam being condensed. However, condensation also invites ambient oxygen to dissolve into the condensate. This process varies with the surface temperature of the condensing droplets. The resulting oxygen entering these vessels would cause corrosion. This risk of corrosion is most pronounced when the flow of flashing steam drops during intermittent flashing, while the cooling coil is continuously trying to remove heat, subcooling the condensate in the process. One method to avoid ambient oxygen from dissolving into the condensate is to continuously modulate the cooling to maintain condensate above target temperature. This requires control and instrumentation, which adds to reliability concerns, capital, operating, and maintenance costs. Besides, residual heat remaining in the vent stream is not being recovered.

For non-atmospherically vented vent recovery, the recovery system would also have to maintain constant pressure balance. This would require even more sophisticated control hardware and safety interlocks. These additional complications further deter feasibility and pose added risk of implosion as described earlier.

Naturally, heat sink capacities associated with vent recovery have practical limits, both in rate and temperature approach. It would be impractical to size for abnormal heat load conditions. Safety relief devices would be required to protect against over pressuring. Incidentally, pressure Safety Valves (PSV) are very expensive for low discharge pressure driving force available for relief, even if the vessel can be rated for a higher operating pressure.

Once the atmosphere venting option is removed, challenges keep multiplying. It would be wise to retain vent to atmosphere as pressure protection when attempting to recover heat, material and perhaps process emissions, if the risks of oxygen entrainment causing corrosion can be averted. A self-controlling heat recovery system requiring little instrumentation would be ideal for such applications.

This invention will demonstrate applications of staged heat and mass transfer concept to provide solutions to the above challenges.

### OBJECTS AND ADVANTAGES

Accordingly, several objects and advantages of this invention are:

The present invention focuses on improving overall operability and reliability at recovering steam vent from a deaerator system.

The present invention enhances control robustness with intrinsic safety features to guard against purge gas reentry to the deaerator.

The present invention focuses on ways to lower operating and maintenance costs in deaerator vent recovery by incorporating hydraulic and pressure self-balancing design features.

The present invention focuses on minimizing installation and equipment costs by capitalizing on available system hydraulics to enable recovery process to work in tandem with deaerator systems at any operating pressure.

The present invention focuses on ways to improve overall quality of deaerator outlet flow and handling capacity to postponed costly capacity increases.

It is another object of this invention to minimize risk of oxygen entrainment into process vessels vented to atmosphere while recovering vent.

It is another object of this invention to illustrate opportunities to retrofit existing vent to atmosphere vessels to allow material recovery, and heat recovery if desirable.

It is another object of this invention to reduce particulate emission by retrofitting existing process vessels vented to atmosphere.

Further objects and advantages of this invention will become apparent from a consideration of drawings and ensuing description.

### DESCRIPTION OF DRAWINGS

FIG. 1 shows arrangement of deaerator vent economizer, prior art.

FIG. 2 shows preferred arrangement of hydraulically balanced deaerator vent economizer.

FIG. 3 shows pressured operated pump deaerator vent economizer arrangement.

FIG. 4 shows preferred arrangement of atmospheric vented economizer.

FIG. 5 shows various arrangement of “first-in first-out” Plug-Flow Capacitance.

FIG. 6 shows preferred arrangement of scrubbing capability in economizer.

### SUMMARY

The summary of this invention is to broaden the application of the staged heat and mass transfer (SHMT) concept to effect efficient separations, heat and product recovery and minimize fugitive emissions to the environment. Two general applications illustrating the improvements based on the original SHMT concept are given. One illustrates commercial applications of recovering vent from a steam boiler deaerator system. The other illustrates process adaptations to recover steam, steam condensate, and fugitive emissions involving particulate materials if desirable, from process vent streams.

### DESCRIPTION OF INVENTION

This invention relates to applying the concept of staged heat and mass transfer (SHMT) to broaden its application. Two groups of applications illustrating the improvements based on the SHMT concept are given. One illustrates commercial applications of recovering vent from steam boiler deaerator systems with enhanced operability, reliability, control robustness and versatility. The other illustrates process adaptations of the SHMT concept to recover steam, steam condensate, and fugitive emissions involving particulate materials if desirable, from any process vent streams.

Deaerator Steam Vent Application

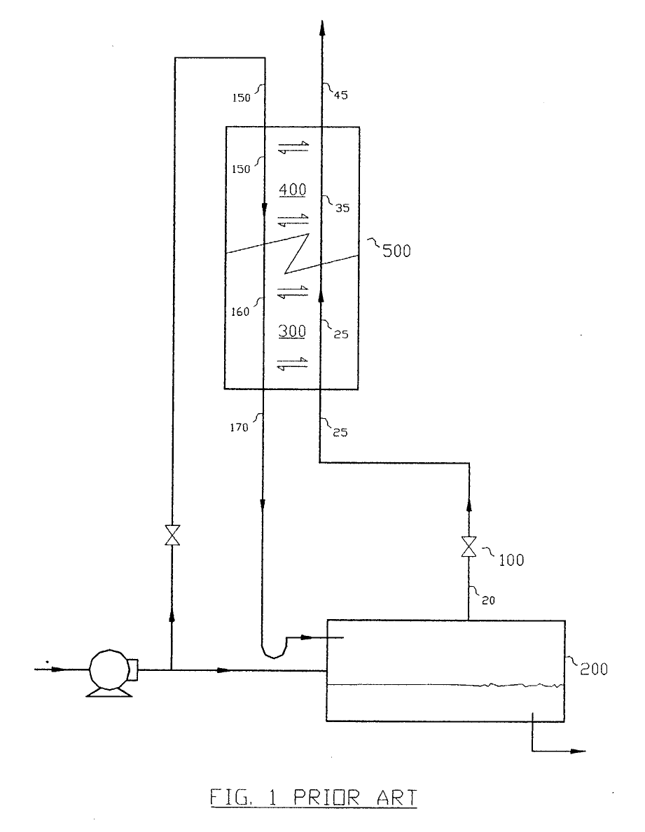

FIG. 1 shows a deaerator steam vent recovery system with a SHMT unit 500, (U.S. patent application Ser. No. 09/536,283) comprised of a heat transfer zone 400 and the mass transfer zone 300, with a movable boundary in between.

The mass transfer zone 300 allows countercurrent contact of vapor stream 25, which is a steam vent from the deaerator, to strip out dissolved gases in liquid stream 160. This mass transfer zone 300 operates like a stripper. Liquid stream 160 is partly deaerated and exits this stripping zone 300 as liquid stream effluent 170, which serves as preheated feed flow to deaerator 200.

The heat transfer zone 400 allows direct contact of liquid stream 150, which is a make-up flow to the deaerator, running downward to scrub out part of the remaining steam content in the vapor stream 35 moving upward. For clarity, vapor stream 25 changes to vapor stream 35 as it crosses the boundary and liquid stream 150 changes to liquid stream 160 as it crosses the boundary. The non-condensables are vented via vent stream 45 while the incoming cold water makeup, liquid stream 150, is brought to thermal equilibrium with the vapor stream 35 at the boundary between the two zones.

Upon closer examination of the above shown arrangement, the deaerator vent 20 crosses a vent valve 100 before entering the SHMT unit 500 as vapor stream 25. In addition, the SHMT unit 500 operates at close to atmospheric pressure since vent stream 45 is vented to atmosphere without restriction. In order for the liquid stream effluent 170 to return to the deaerator, large elevation difference is required between the SHMT unit 500 and the deaerator 200. The head requirement depends on the operating pressure of the deaerator system as explained below:

Since the SHMT unit 500 is opened to the atmosphere without restriction, it is essentially operating at atmospheric pressure. Most deaerators operate at some pressure level above atmospheric pressure, say between 3 psig to 15 psig or higher, elevation difference has been proposed to overcome this pressure resistance in said prior art reference.

The liquid stream effluent 170 can return into the deaerator 200 only with sufficient pressure provided by elevation difference, i.e. hydrostatic head. In addition, deaerator inlet are often equipped with spring loaded spray heads provided to better disperse water droplets for faster warm up of inlet water. This further increases resistance for the liquid stream effluent 170 returning to the deaerator.

In addition, deaerator pressure could fluctuate during unsteady operation. Should this happen, flooding could occur due to liquid backing up in the SHMT unit 500. Consequently, “suitable elevation” could be impractical, if not prohibitive, in a plant environment.

The other area of improvement lies in the control of the unit. Temperature control target could be set too low so that the mass transfer zone 300 may not be adequately stripping out the dissolved gases. In other words, the boundary between the two zones does not favor stripping but encourages quenching so that carbon dioxide and oxygen concentration would rise in the SHMT unit 500. As a practical example, the unit could be initially well balanced with a constant vent flow, vapor stream 25, from the deaerator. Colder or more feed water, liquid stream 150 will unset the heat balance. Similarly, lower deaerator pressure at constant valve opening would reduce deaerator vent 20 from the deaerator, consequently lower vapor stream 25. Lower heat input rate with constant quenching also unsets the heat balance.

From the above analysis, an improved system to avoid the above shortcomings to provide reliable SHMT operations is still missing.

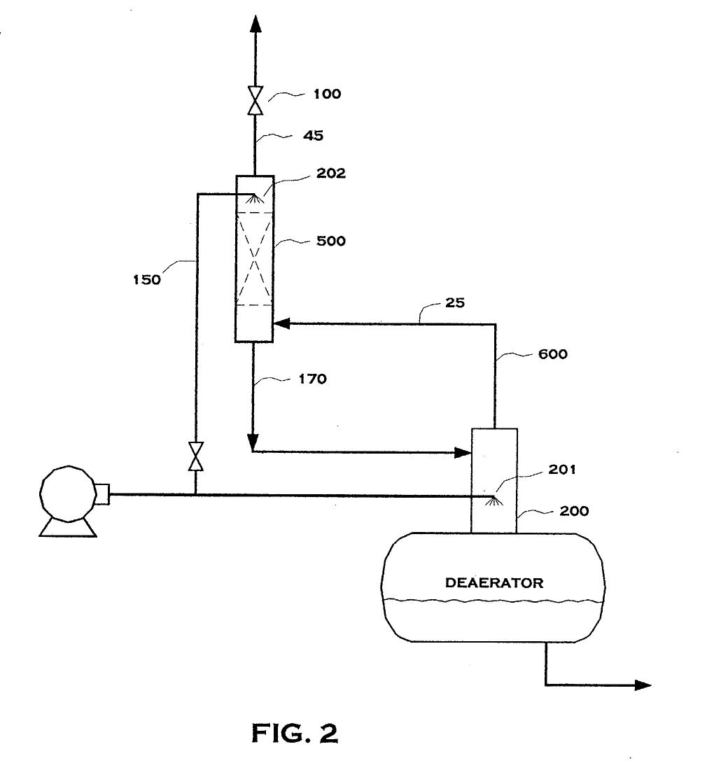

FIG. 2 shows an improved arrangement of the SHMT unit 500. In stead of the SHMT unit 500 being attached to a deaerator 200, it is configured so that it becomes part of the deaerator system. Note that the vent valve 100 has been relocated downstream of vent stream 45. The following details provide a transformed system pressure and heat balance control behavior.

The vent valve 100 now throttles to control a preset amount of venting.

There is no longer any restriction in between the SHMT unit 500 and the deaerator 200.

The operating pressure can be made essentially the same with adequately sized vapor line 600, providing unrestricted flow from the deaerator 200 to the SHMT unit 500.

The liquid effluent 170 now discharges into the deaerator head area, unaffected by the spray nozzle 201 pressure drop.

Spray nozzle 202 can be provided to increase effective area in heat transfer zone 400 within the SHMT unit by spraying feeding the liquid stream 150.

The following is a detailed analysis of the improved deaerator vent recovery arrangement:

Hydraulic Balance

Liquid effluent 170 can return to deaerator by gravity as shown in FIG. 2 provided the line loss due to flow of vapor stream 25 is minimal by adequately sizing vapor line 600. The pressure at this return location for liquid effluent 170 is practically the same as the vapor stream 25 outlet right from the deaerator 200. Therefore, a typical 3 to 5 feet of elevation difference would be ample to overcome liquid effluent 170 line losses. Self-venting line to handle both vapor and liquid flow can also be used as an alternative by those skilled in the art.

Heat Balance

The heat balance analysis reveals many unexpected results, first, the background.

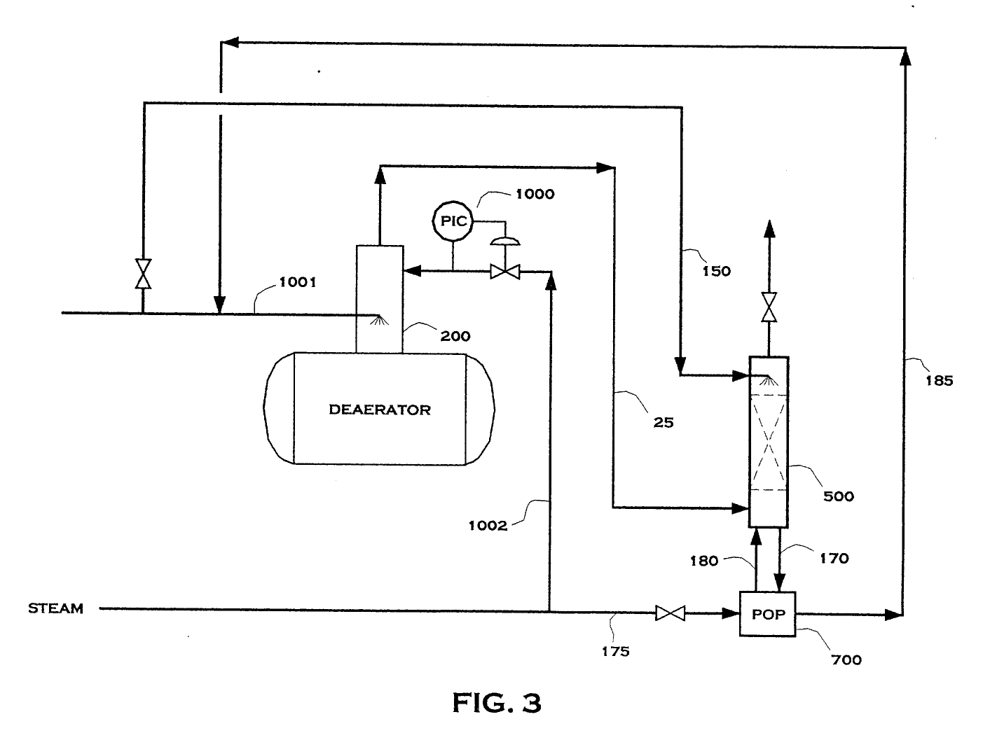

All deaerator comes equipped with pressure controller 1000 as shown in FIG. 3 to balance the heat load. As more or less feed water 1001 is introduced into the deaerator 200, more or less steam flow 1002 will be required to bring the feed water 1001 to the same boiling temperature after it enters the deaerator 200. This process relationship causes the steam inventory in the deaerator 200 to change, reflecting the pressure of the deaerator 200. Constant pressure for steady deaerator operation is maintained by steam flow 1002 adjustment to the deaerator 200, controlled by a pressure controller 1000.

FIG. 2 shows liquid stream 150 entering a pressure controlled environment maintained by a typical pressure controlled deaerator 200 (similar to the one shown in FIG. 3). Variations in the flow of liquid stream 150 to the SHMT unit 500 are compensated automatically by the existing pressure controller (not shown) since the SHMT unit 500 and the deaerator 200 are tied together as one pressure system.

Combined Effect on Operability and Effectiveness

As can be seen, this integrated arrangement greatly simplifies the heat balance control, eliminates the risk of over quenching and guarantees a liquid outlet. The maximum flow rate of steam, as indicated by vapor stream 25 entering the SHMT unit 500, is predetermined by the quench duty. Spray head 202 at entry point further increases effective heat transfer area so that the SHMT unit can allocate more resource for stripping activity in the mass transfer zone, moving up the movable boundary (see movable boundary in FIG. 1). The vent stream 45 from the top of SHMT unit 500 via vent valve 100 is typically a few percent of the original deaerator vent, vapor stream 25. This steady vent guarantees steady purging of oxygen and carbon dioxide gases.

Further Process Impact Analysis

Another area of unexpected result lies in the forced temperature profile across the SHMT unit 500 provided by the above mentioned vent stream 45 as explained below:

The vent stream 45, powered by the pressure difference between the SHMT unit 500 and the atmosphere, provides positive venting to avert oxygen and CO2 gas accumulation in the SHMT unit 500 and deaerator 200 system. By material balance, this continuous venting lowers the oxygen and CO2 concentration in the SHMT unit 500 such that the environment around the liquid stream 150 inlet via spray head 202 is almost all steam. This resulting almost pure steam environment, corresponding to maximum dew point temperature, further deters oxygen and CO2 solution into the condensate. Lower dissolved gases means less stripping load in the mass transfer zone. The combination of improved heat and mass transfer effectiveness enable reduced overall equipment and installation costs, by simply capitalizing on this very important temperature profile concept not readily apparent. This temperature profile technique is certainly another unexpected result of this invention.

Surface Chemistry

From a surface chemistry perspective, preventing dissolved gases from reentering the deaerator begins with the temperature profile across the SHMT unit. Partition coefficient is defined as the preference of a gas to stay in the vapor phase or as dissolved gas in a liquid, as in this condensing environment in the heat transfer zone. Temperature is the overriding factor. If the temperature is kept high enough, gas solubility will be negligible. Less dissolved gas in the condensate needs less stripping in the mass transfer zone. This invention combines the material balance (purer steam) and surface chemistry effects (partition coefficient) to minimize gas dissolution by adopting the preferred control method of keeping a small vent flowing off the top at all times. From a material balance perspective, this small vent can be between any reasonable number but preferably, around 5%, corresponding to 95% recovery. Therefore, this vent rate concentrates the vent gases by 20 times. Since oxygen and other gases are in parts per million at the inlet of the SHMT unit, outlet concentration is no more than a few percent. Therefore, the vent stream 45 is practically all steam. Vent stream 45 is located very close to the spray nozzle 202. Although the temperature drops at the heat transfer zone due to the quenching effect, the temperature profile across the top section of the SHMT unit is much elevated by this small purge. Consequently, soluble gases are discouraged to dissolve in the liquid. That is one of the strong advantages this current invention provides over prior art at minimizing stage requirement for mass transfer and reducing overall capital cost.

Overall Capacity Increase

This application of staged heat and mass transfer can be added to any existing deaerator vent stream without compromising on safety, operability, and capacity of the original venting requirement. The diverted small portion of the feed as liquid stream 150 to the SHMT unit 500 can be returned to the deaerator head to be further polished, or to the holding tank, depending on the deaeration requirement. Obviously, the overall capacity of the deaerator system is increased because of this feed flow diversion, allowing higher total flow to the system.

Pressure Operated Pump Alternative

An alternate set-up is shown in FIG. 3 where the pressure head requirement in FIG. 2 is provided by a pressure operated pump (POP) system 700. By providing a POP system 700, tight locations such as boiler room on ships or tight head room in manufacturing facilities or deaerator facilities resting on excessively tall structures can also utilize a SHMT unit for vent recovery. Very briefly, POP uses a motive fluid at higher pressure such as steam or compressed air to pump liquid by providing the head lift required. The receiving tank in POP 700 moves liquid effluent 170 in a pressure/vent cycle for discharging/filling, respectively, in a batch by batch sequence. Liquid effluent 170 enters POP 700, which has been depressurized and is vented back to SHMT unit 500, by gravity in the fill cycle. Pressure provided by motive steam 175 starts to pressurize POP 700 when its level reaches a reset limit, triggered by mechanism similar to a toilet tank float operator. Check valves ensures proper flow pattern. After the liquid level returns to preset level, the fill cycle begins again to allow POP 700 to accept gravity flow of liquid effluent 170. In this application, steam would be an ideal motive force since the vent steam 180 from the POP 700 can be easily recycled into the system. No motive steam 175 is wasted and the liquid effluent 170 from the SHMT unit can be returned as recycled feed 185 to the deaerator 200, upstream of the feed spray nozzle. Vent steam 180 from the POP 700 is returned to the SHMT unit 500 after the pressure cycle. The above arrangement requires one additional pumping means which can also be provided by other types of pumps or the like to replace the elevation requirement. The rest of the advantages like duty control and purge gas assurance remain unaffected.

Another adaptation for the SHMT concept can be applied to recover condensate and heat and to minimize particulate or odor emissions to the environment, while retaining the atmospheric venting convenience. As explained in earlier discussion, the main difficulty is atmospheric oxygen egress into the vessel, especially when the recoverable heat load tend to fluctuate. Traditional vent condensers (cooling coil type or others) cannot cope with changing heat load on demand, unless elaborate control scheme and instrumentation is involved. This invention enables material and/or heat recovery without risking oxygen egress. Three elements are required to achieve this difficult task in a passive manner. No control instrumentation is needed.

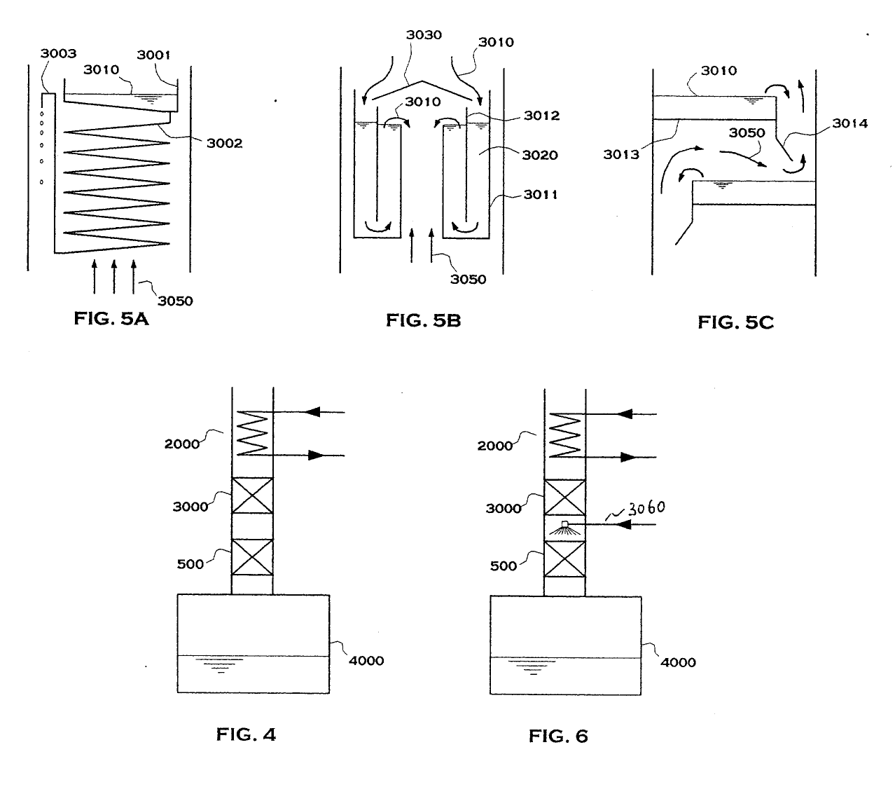

As shown in FIG. 4, the three elements are as follows. Cooling means 2000 at the top, SHMT unit 500 at the base and plug-flow capacitance (PFC) 3000 in between. These three elements reside along the vent path of a vessel 4000 vented to the atmosphere.

Cooling Means

Cooling means 2000, could be the cooling coil type heat exchanger, recovering heat for other uses by a cooling fluid, or fin type air coolers that simply reject waste heat to ambient. In fin typed coolers, it could simply be an elongated pipe with increased surface area to encourage heat loss to ambient. The essential difference besides no control instrumentation being required is the latitude of heat duty. In other words, the duty sizing can be very forgiving.

Staged Heat and Mass transfer Unit

The SHMT unit 500 has been well explained in this specification. The purpose of this element is to provide quenching and stripping capabilities as explained before. The downward flowing condensate, generated by the cooling means 2000, is stripped of dissolved gases. The SHMT unit 500 is effective even if the condensate entering the top of the SHMT unit 500 initially contains saturated amount of dissolved gases. Stripping is accomplished by up coming hot vapor from the vessel 4000.

Combining Cooling Means and SHMT Unit

When the cooling means 500 and the SHMT unit 500 are working in tandem, they can recover practically all the heat and condensate and prevent oxygen egress brought on by traditional vent condensers. That capability is intact even if the condensing capacity is much over sized. The reason is based on material balance as follows.

For illustration purpose, let us assume that the cooling means 2000 is capable of condensing all condensables in the vapor stream plus subcooling the resulting condensate to a minimum possible temperature attainable. That temperature is governed by the temperature approach and essentially cannot be lower than the temperature of the cooling medium. In terms of the amount of condensate, the mass cannot exceed the vapor flow from the vessel. With these as boundary limits, the SHMT unit 500 can comfortably be designed to perform the necessary quenching (bring condensate to saturation temperature) and stripping (remove dissolved oxygen) so that the outlet condensate is free of dissolved oxygen. The exercise is simply a shift of operating pressure of the deaerator unit discussed in detail earlier. However, SHMT unit 500 relies on vapor flow from the vessel 4000 in order to power the mass transfer zone. Should this vapor flow be suddenly interrupted, mass transfer zone would not work to strip out dissolved oxygen and oxygen break through would occur.

Plug-Flow Capacitance

In order to guard against oxygen egress, the plug-flow capacitance PFC 3000 element is introduced. It is based on the “first-in, first-out” concept to control liquid traffic as the primary objective followed by providing heat transfer area to reduce heat transfer duty requirement in the SHMT unit 500 as secondary objective.

The PFC 3000, by definition, provides a plug-flow type of holdup to the entire condensate inventory in transit. It is also in direct contact with vapor 3050 flowing upward from the SHMT unit 500 and the cooling means 2000 so that the inventory it holds can gain heat by conduction and convection. FIG. 5A, B, C show various mechanical arrangements that can accomplish the two objectives. FIG. 5A shows a holdup tray 3001 connected to a coiled tubing 3002 oriented such that the condensate 3010 collected must travel via the coiled tubing 3002 and be heated up before discharging from straight discharge 3003. The elevation between the holdup tray 3001 and the straight discharge 3003 determines the liquid inventory in the PFC 3000. With that understanding, a properly sized and designed PFC 3000 can provide total holdup capacity for condensate 3010 generated by the entire condensing surface of the cooling means 2000. Therefore, all the condensate 3010 can enter and leave in a “first-in, first-out” manner, reflecting true attenuation. Obviously, the purpose is to enable the SHMT unit 500 to pick up where it has left off at any time and be immune to vapor flow 3050 interruption.

FIG. 5B shows another PFC 3000 arrangement that has an annulus holdup tray 3011 where the condensate 3010 passes through baffled partition 3012 as shown by arrows. Chimney hat 3030 prevents condensate 3010 from bypassing the PFC 3000. Exposed area provides heat transfer area.

FIG. 5C shows a traditional tray and downcomer with a modified solid bottom nonperforated tray 3013 with shortened downcomer 3014. Condensate 3010 is held up in nonperforated tray 3013 and overflows via shortened downcomer 3014 to the tray below. Vapor flow 3050 is free to travel via shortened downcomer 3014.

Those skilled in the art would be able to come up with many other designs reflecting the plug-flow capacitance concept without departure from the spirit and concept of this invention.

Liquid Scrubbing Capability

For additional environmental consideration, liquid sprays 3060 can be inserted between the PFC 3000 and the SHMT unit 500 as shown in FIG. 6. Liquid sprays 3060 can be controlled in a prescribed rate to wash down particulate emissions entrained in the vapor 3050 as well as keeping the SHMT unit 500 clean. This could help return a waste stream as a useful product stream and help improve profitability. In beer brewery industry or food industry, batch recipe can be adjusted to accommodate this added liquid spray and the recovered condensate so that heat energy and materials can be conserved in batch cooking processes.

Additional Ramifications

This invention provides practical applications of the staged heat and mass transfer concept to allow cost effective retrofitting to any existing deaerator to recover the otherwise wasted steam. At the current climate of energy deregulation, power/steam co-generation facilities for capturing power and steam users' market can benefit tremendously from the current invention. Most non-utilities based co-generation facilities, supplying steam users that are quite a distance away, need to process considerable amounts of condensate make-up since condensate return pose more logistic challenges. Deaerator venting is more pronounced for higher oxygen loading because of higher make-up water rate. This invention impacts favorably by recovering practically all the current venting.

The extended application of the atmospheric vent recovery in this current invention opens many doors to a host of direct and indirect venting to atmosphere processes. Examples can be found in process mixing tanks, food and beverage batch processes, dryer economizers in the pulp and paper industry and the list goes on. This application provides a tangible method to buffer the atmospheric oxygen by preventing oxygen egress into process tanks, yet allows the atmospheric vent as a pressure protection. These applications are nothing less than extensive exploitations of the staged heat and mass transfer concept.

### CONCLUSION, RAMIFICATIONS, AND SCOPE OF INVENTION

Thus, the reader will see that this invention truly provides practical solutions to solve process problems in a novel and useful perspective. In essence, the present invention provides a practical and thermodynamically sound alternative in the field of separation processes. While the above description contain many specificities, these should not be construed as limitations on the scope of the invention, but rather as exemplification on preferred embodiments thereof. Many other variations are possible. Examples can be found in the energy related industries, petrochemical and oil refinery processes, pulp and paper industries, pharmaceutical manufacturing processes and food and beverage applications and the list go on.

1. A system for recovering steam vent from a deaerator comprising of:
a deaerator vent recovery unit, said unit further comprises at least one direct contact heat transfer zone for quenching and at least one mass transfer zone for stripping, said at least one direct contact heat transfer zone is located above said at least one direct contact mass transfer zone, operating in series, separated by a movable boundary, said boundary is movable within the deaerator vent recovery unit to adjust said quenching and said stripping,
means for providing at least one liquid stream to the deaerator vent recovery unit, said at least one liquid stream to the deaerator vent recovery unit enables quenching,
means for providing at least one vapor stream to the deaerator vent recovery unit, said at least one vapor stream to the deaerator vent recovery unit enables stripping,
means for maximizing temperature profile across the deaerator vent recovery unit,
to effect migration of condensable components from the at least one vapor stream to the at least one liquid stream before discharging as liquid stream effluent, and migration of soluble components from the at least one liquid stream to the at least one vapor stream before discharging as vent stream and,
means for removing said liquid stream effluent from the deaerator vent recovery unit,
means for removing said vent stream from the deaerator vent recovery unit,

2. The system according to claim 1 wherein said means for providing at least one liquid stream to the deaerator vent recovery unit is a diverted small portion of feed flow to a deaerator,

3. The system according to claim 1 wherein said means for providing at least one vapor stream to the deaerator vent recovery unit is an unrestricted flow from said deaerator,

4. The system according to claim 1 wherein the means for maximizing temperature profile across the deaerator vent recovery unit comprises the combined effects of continuously purging out said soluble components to maximize dew point temperature and increase effective area in heat transfer zone by spraying feeding the at least one liquid stream,

5. The system according to claim 1 wherein the means for removing the liquid effluent stream comprises of, providing adequate elevation between the deaerator vent recovery unit and the deaerator so that the liquid effluent stream can return to the deaerator from the deaerator vent recovery unit by gravity, and, adequately sizing vapor connection between the deaerator and the deaerator vent recovery unit,

6. The system according to claim 1 wherein the means for removing the liquid effluent stream comprises of providing a pressure operated pump,

7. The system according to claim 1 wherein the means for removing the vent stream comprises of, minimizing pressure difference between the deaerator and the deaerator vent recovery unit through adequate line sizing, and providing vent valve to control flow rate of the vent stream,

8. A system for recovering process vent from a vessel vented to the atmosphere comprising of:
a staged heat and mass transfer (SHMT)unit comprised of at least one direct contact heat transfer zone for quenching and at least one mass transfer zone for stripping, said at least one direct contact heat transfer zone is located above said at least one direct contact mass transfer zone, operating in series, separated by a movable boundary, said boundary is movable within said SHMT unit to adjust said quenching and said stripping,
cooling means for providing heat removal from said process vent, said cooling means resides above the SHMT unit,
means for providing Plug-Flow Capacitance (PFC), said PFC means resides in between the SHMT unit and the cooling means,
to recover any combination of elements selected from a group consisting of heat energy, condensate, odor and particulate emissions, without oxygen egress into the vessel,

9. The system according to claim 8 further comprises liquid spray means to wash down particulate emissions and provide liquid scrubbing capability,

10. The system according to claim 8 wherein the cooling means is selected from a group consisting of cooling coil and finned tube heat exchanger,

11. The system according to claim 6 wherein the PFC means is selected from a group consisting of mechanical arrangements shown in FIGS. 5A, FIG. 5B and FIG. 5C of this specification.
